(19) United States
(12) Patent Application Publication
(10) Pub. No.: US 2015/0008603 A1
(43) Pub. Date: Jan. 8, 2015

(54) De-warping Appliance for Vinyl Records

(71) Applicant: John H. Martindale, Royse City, TX (US)

(72) Inventor: John H. Martindale, Royse City, TX (US)

(21) Appl. No.: 13/937,144

(22) Filed: Jul. 8, 2013

(51) Int. Cl. B29C 73/30

(52) U.S. Cl. CPC B29C 73/30
USPC 264/36.13; 425/11

(57) ABSTRACT

The present invention relates to an improved device and method for de-warping a warped vinyl record so that it may be played and enjoyed.

### CROSS-REFERENCE TO RELATED APPLICATIONS

This application takes benefit of U.S. Provisional App. No. 61/669,106 filed Jul. 8, 2012 which is hereby included in its entirety by reference.

### FIELD OF THE INVENTION

The present invention relates to a device for de-warping a vinyl record so that it may be played and enjoyed.

### BACKGROUND OF THE INVENTION

Vinyl records were the primary medium for the recordation and distribution of audible information and entertainment from the 1920s through the early 1990s. At that time they were largely supplanted by various forms of digital media. However, throughout the first decade of this century vinyl records have undergone a new surge in popularity as professional “disc jockeys” and audiophiles have driven demand for newly recorded material. Audiophiles in particular have always been enamored of vinyl records with many maintaining that a performance reproduced from a vinyl record is vastly superior to the same performance recorded by means of digital media. Moreover, many performances recorded in the past century have never been made available, and may never be made available, in any form other than a vinyl record. As a result, interest in vinyl records remains strong even several decades after their supposed technological obsolescence.

Unfortunately, vinyl records demonstrate many of the same failings of their earlier counterparts, to wit, a tendency to wear from use and a tendency to warp from improper storage. Depending on its severity, this so-called cold-flow deformation may render the recording essentially useless. Fortunately, the copolymerized vinyl acetate and vinyl chloride compounds used to make most vinyl records has the desirable property of being readily reformed and permanently flattened by means of pressure and heat.

Various appliances and means for de-warping vinyl records are well known and described in the prior art. These range in complexity from simple sheets of glass between which the vinyl record is sandwiched and then placed in a conventional oven to electrically heated appliances into which the record is placed and then automatically de-warped.

However, all the techniques and appliances extant in the prior art suffer from the same three disadvantages, to wit: 1) The inability to precisely select the pressure applied to the record during the de-warping process; 2) Apply pressure only to the recorded surface of the record (versus the peripheral, outer lead in area of the record and central elevated lead out with its paper label); 3) The lack of certainty that the pressure is uniformly applied to the recorded surface of the record; and 4) The ability to use the device in the absence of heat, as would be required in the case of a rare or costly record. The first disadvantage occurs because vinyl records vary in thickness and the pressure necessary to reform them properly varies depending on the thickness. The techniques and appliances extant in the prior art demonstrate no capacity to accurately vary and consistently measure the pressure applied to the record being reformed. The second disadvantage occurs because vinyl records are not planar. More specifically, when viewed in longitudinal cross-section, a vinyl record is thicker at the peripheral, circumferential lead-in area than it is in the grooved playing area. Also, a vinyl record is slightly thicker at the central lead out area of the record by virtue of the paper label always affixed to both sides of the record. As a result, simple techniques using sheets of glass or other rigid materials are less than optimal because the heated glass or other material contacts only the raised peripheral, circumferential lead-in area of the record and raised central paper label and not the lower recorded surface of the record. As a result, the warped surface of the record is largely untouched and thus remains, even at best, slightly warped. The third disadvantage occurs because the record must be precisely located between the upper and lower pressure areas to ensure that pressure is applied to the recorded surface versus the raised peripheral, circumferential lead-in area of the record and raised central paper label. This shortcoming is particularly acute in devices that use a hinged top and bottom and some mechanical means of setting the pressure to be exerted on the record in that the insufficient care is taken to ensure that the pressure applied to the record is evenly distributed. With respect to the fourth disadvantage, while various methods for de-warping records without heat are disclosed in the prior art, none solve the foregoing three problems simultaneously.

### SUMMARY OF THE INVENTION

It is an object of the present invention to provide an improved de-warping appliance for vinyl records that: 1) Is easy to construct and easy to use; 2) Evenly applies a reforming force to the warped playing area of the record and not to the raised peripheral, circumferential, lead-in portion of the record or raised central paper label; 3) Provides a simple, reproducible means of providing an even downward force applied to the recorded playing surface of warped records of varying thickness; and, 4) May be, if desired, used without heat.

### BRIEF DESCRIPTION OF THE DRAWINGS

FIG. 1 is a diagram illustrating the top portion of a first embodiment of the de-warping appliance in plan view.

FIG. 2 is a diagram illustrating the bottom portion of a first embodiment of the de-warping appliance in plan view.

FIG. 3 is a diagram illustrating a longitudinal cross-section of a first embodiment of the de-warping device showing its manner of use.

FIG. 4 is a diagram illustrating the top portion of a second embodiment of the de-warping appliance in plan view.

FIG. 5 is a diagram illustrating the bottom portion of a second embodiment of the de-warping appliance in plan view.

FIG. 6 is a diagram illustrating a longitudinal cross-section of a second embodiment of the de-warping device showing its manner of use.

FIG. 7 is a diagram illustrating the de-warping device showing its manner of use with the heating sleeve.

### DETAILED DESCRIPTION OF THE EMBODIMENTS

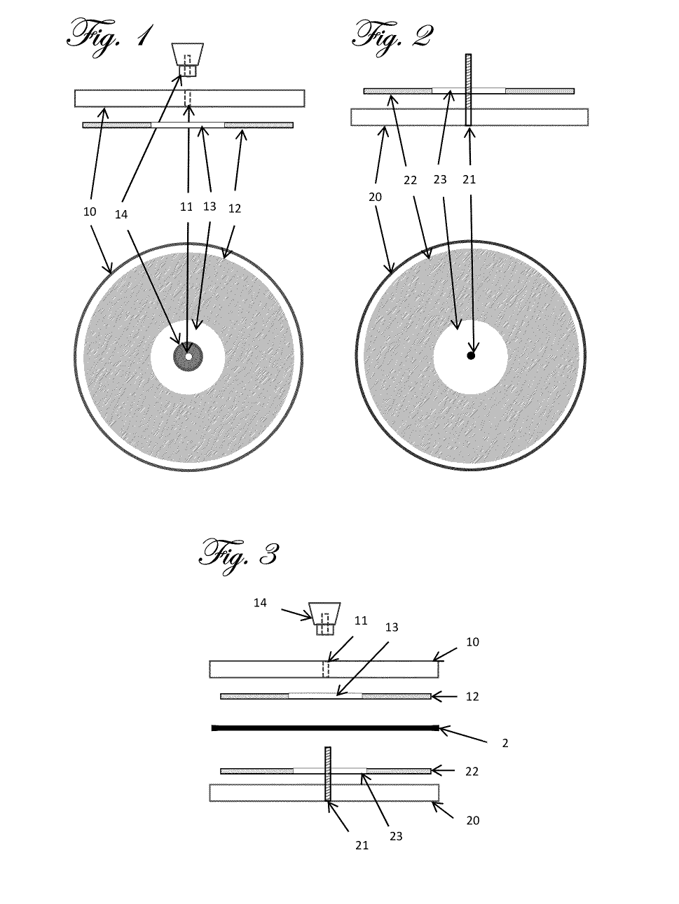

In the first embodiment, pictured specifically in FIGS. 1, 2, and 3, the bottom half of appliance 20 and the top half of appliance 10 may be constructed of numerous rigid materials, including, but not limited to, metal, glass, stone, and ceramic. First bottom annular spacer 22 is centered on top of the top surface of the bottom half of the appliance 20 with bottom central circular cavity 23 centered over threaded central shaft 21. First bottom annular spacer 22 is constructed of some relatively incompressible substance such as neoprene, high-density polyethylene (HDPE), polyetheretherketone (PEEK), polymethylmethacrylate (PMMA), metal, glass, stone. Record 2 to be de-warped is then placed over threaded central shaft 21 and on top on of first bottom annular spacer 22. The circumferential, lead-in portion of record 2 protrudes beyond the edge of first bottom annular spacer 22. Similarly, the raised central paper label of record 2 rests in lower central circular cavity 23 cut in first bottom annular spacer 22. As a result, only the warped playing area of 2 record contacts the planar, top surface of first bottom annular spacer 22. First top annular spacer 12 is then centered on top of record 2 with top central circular cavity 13 over threaded central shaft 21 of the bottom portion of the appliance such that the circumferential, lead-in portion of record 2 protrudes beyond the edge of first bottom annular spacer 22. Similarly, the raised central paper label on top of record 2 rests in top central circular cavity 13 cut in first top annular spacer 12. As a result, only the warped playing area of record 2 contacts the planar, bottom surface of first top annular spacer 12. First top annular spacer 12 is constructed of some relatively incompressible substance such as neoprene, high-density polyethylene (HDPE), polyetheretherketone (PEEK), polymethylmethacrylate (PMMA), metal, glass, or stone. The top portion of the appliance 10 is then slipped over threaded shaft 21. Since the appliance is designed to apply the appropriate downward force to flatten the record by means of gravity alone and since vinyl records are constructed in a multiplicity of thicknesses, top portion of the appliance 10 may be supplied in a variety of thicknesses and weights ranging from about 3 to about 6 pounds. The appliance has a threaded knob 14 or equivalent means for securing the top portion of the appliance 10, first top annular spacer 12, record 2, first bottom annular spacer 22, and the bottom portion of the appliance 20 together by means of screwing threaded knob 14 onto threaded central shaft 21.

In the second embodiment, pictured specifically in FIGS. 4, 5, and 6, the bottom half of appliance 20 and the top half of appliance 10 may be constructed of numerous rigid materials, including, but not limited to, metal, glass, stone, and ceramic. Second bottom annular spacer 40 is placed on the top surface of the bottom half of the appliance 20 with bottom hole 41 slipped over threaded central shaft 21. Second bottom annular spacer 40 is constructed of some compressible substance such as felt, polyester felt, rubber, or plastic foam sheet. Record 2 to be de-warped is then placed over threaded central shaft 21 and on top on of second bottom annular spacer 40. The edge of second bottom annular spacer 40 protrudes beyond the circumferential, lead-in portion of record 2. Since second bottom annular spacer 40 is constructed of a soft, compressible material, it readily conforms itself to the bottom surface of record 2 thus applying equal upward pressure on the playing surface of record 2 and the higher lead-in and raised paper label affixed to record 2 when the appliance is closed. As a result, the raised central paper label, raised lead-in, and the lower warped playing surface on the bottom of record 2 are held in intimate contact with the top surface of second lower annular spacer 40 when the appliance is closed. Second top annular spacer 30 is placed on top of record 2 with top hole 31 slipped over threaded central shaft 21. Second top annular spacer 30 is also constructed of some compressible substance such as felt, polyester felt, rubber, or plastic foam sheet. The edge of second bottom annular spacer 30 protrudes beyond the circumferential, lead-in portion of record 2. Since second top annular spacer 30 is constructed of a soft, compressible material, it readily conforms itself to the top surface of record 2. As a result, the raised central paper label, raised lead-in, and the lower warped playing surface on the top of record 2 are held in intimate contact with the bottom surface of second top annular spacer 30 when the appliance is closed. The top portion of the appliance 10 is then slipped over threaded shaft 21. Since the appliance is designed to apply the appropriate downward force to flatten the record by means of gravity alone and since vinyl records are constructed in a multiplicity of thicknesses, top portion of the appliance 10 is supplied in a variety of thicknesses and weights ranging from about 3 to about 6 pounds. The appliance has a threaded knob 14 or equivalent means for securing the top portion of the appliance 10, second top annular spacer 30, record 2, second bottom annular spaced 40, and the bottom portion of the appliance 20 together by means of screwing threaded knob 14 onto threaded central shaft 21.

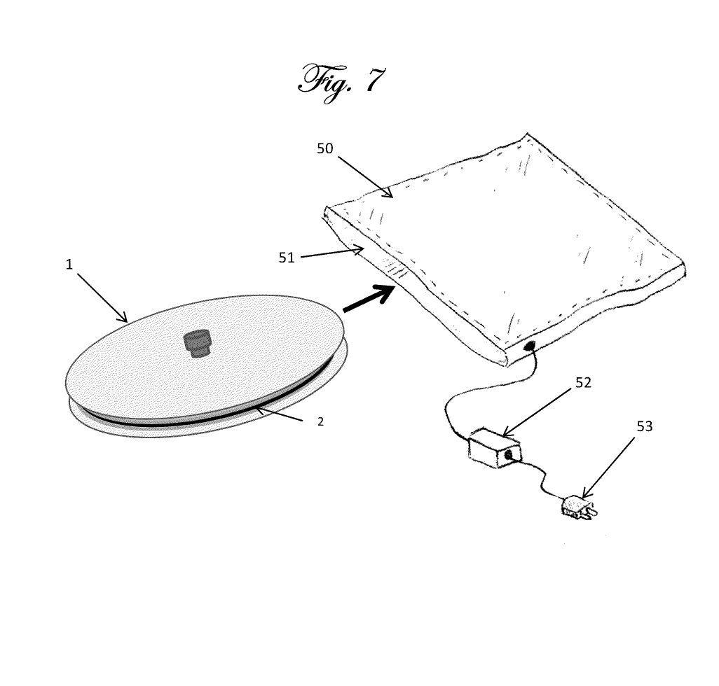

Turning now to FIG. 7, while both described embodiments of the present invention may be used at room temperature, or, alternately placed inside in an existing external heating device such as a kitchen oven, both may also be used with heating pouch 50. Heating pouch 50 is preferably comprised of fire-resistant cloth or synthetic cloth with carbon fiber heating elements, carbon nanotube heating cloth, fire-resistant cloth or synthetic cloth with Teflon Microwire™ heating elements, or fire-resistant cloth or synthetic cloth with conventional heating wires. Heating pouch 50 is heated by means of electricity, preferably a low voltage DC supply as provided by AC to low voltage DC converter 52, connected to a standard 110V A/C supply by means of standard plug 53. Incorporated in the low voltage DC electrical circuit within heating pouch 50 is a thermostat. This thermostat is used to vary the nominal operating temperature of heating pouch 50 within a range between about 110° F. and about 150° F. Obviously, by substituting AC to low voltage DC converter 52, heating pouch 50 may be powered by any source of AC electric current. Similarly, a direct DC connection obviates the need for AC to low voltage DC converter 52. Of course, AC powered variants of heating pouch 50 are included within the scope of the disclosure.

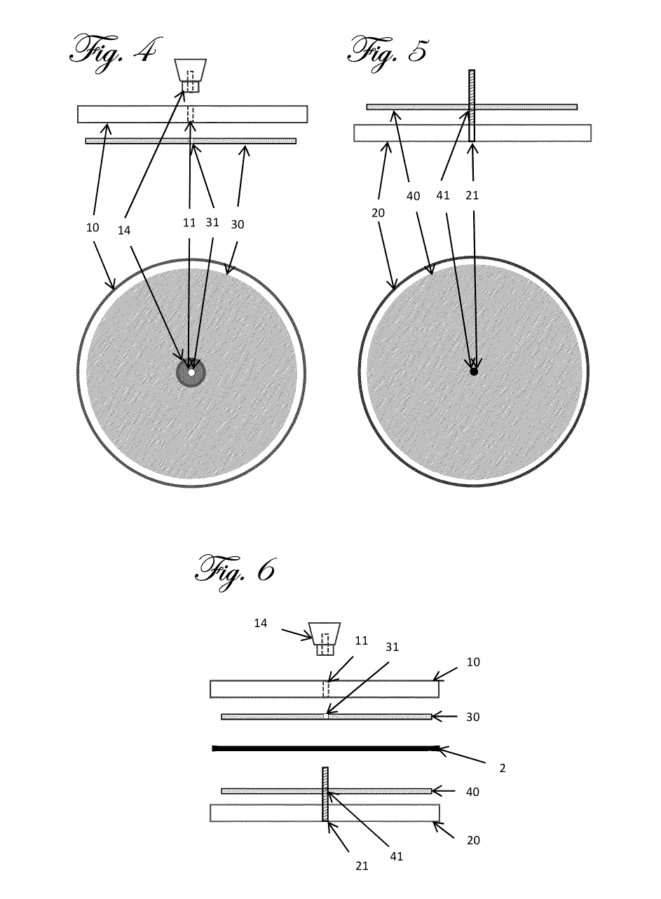

Referring now to FIGS. 3, 6, and 7, to use the disclosed embodiments record 2 is placed in appliance 1. Then the user may perform three different, mutually exclusive, steps:

First, the user may place appliance 1 with enclosed record 2 at room temperature and let the force of gravity acting on the top half of the appliance 10 flatten the playing surface of record 2. This process takes an indeterminate period of time ranging from about week to about four months and varies based on: 1) The average room temperature; 2) The relative humidity; 3) The thickness of record 2; 4) The amount of deformation present in the playing surface of record 2; and, 5) The weight of the top half of appliance 10.

Second, the user may place appliance 1 with enclosed record 2 in a conventional kitchen oven at a temperature in the range between about 110° F. and about 150° F. Assuming light deformation in the playing surface of the record and assuming the weight of the top half of appliance 10 is in the range of about 3 to about 6 pounds, the amount of heating time required to flatten the playing surface of record 2 varies from about 40 minutes to about 70 minutes. However, the amount of time necessary to flatten the record may vary depending on the amount of deformation present in the playing surface of record 2.

Third, the user may place appliance 1 with enclosed record 2 in heating pouch 50 and connect heating pouch 50 to a supply of electricity. While the heating elements in heating pouch 50 may be set to a temperature in the range between about 110° F. and about 150° F., the interior of the pouch is somewhat cooler because the pouch is not heavily insulted and is not completely airtight like most kitchen ovens. Assuming light deformation in the playing surface of the record and assuming the weight of the top half of appliance 10 is in the range of about 3 to about 6 pounds, the amount of heating time required to flatten the playing surface of record 2 varies from about 4 hours to about 20 hours. However, the amount of time necessary to flatten the record may vary depending on the amount of deformation present in the playing surface of record 2.

In the discussed embodiments, appliance 1 may incorporate its own integral electric heating elements in the top and bottom portions of the appliance and suitable electronic circuitry to closely control the temperature at which to de-warping process occurs and the time interval for which record 2 is de-warped. Moreover, in these embodiments an audible alerting and/or timing device may be included, whether incorporated into appliance 1 itself, or in a housing unto itself, said audible alerting device being used to inform the user that the de-warping process is complete and de-warped record 2 may be retrieved

In the discussed embodiments, a thermometer, or other device for measuring and visually reporting the temperature at which the de-warping process is occurring, may be affixed to, or constructed within, the appliance 1 or heating pouch 50.

While the invention has been described in connection with what are considered to be the most practical and preferred embodiments, it is to be understood that the invention is not to be limited to the disclosed embodiments, but on the contrary is intended to cover various modifications and equivalent arrangements included within the spirit and scope of the disclosure.

What is claimed is:

1. A first improved de-warping appliance for vinyl records, comprising:
a) a flat, circular base plate of large radius constructed from a material comprising a selection from a group consisting of:
i. metal, and
ii. glass, and
iii. ceramic, and
iv. stone;
b) a threaded central shaft projecting perpendicularly up from said circular base plate at the center point of said circular base plate;
c) a first lower circular spacer:
i. wherein said first lower circular spacer has an outer radius about ¼″ less than the radius of the record to be used with the appliance, said radius comprising a selection from a group consisting of:
(1) the radius of a 12″ (30 cm) 33⅓ RPM long play record, and
(2) the radius of a 12″ (30 cm) 33⅓ RPM maxi single record, and
(3) the radius of a 12″ (30 cm) 45 RPM maxi single record, and
(4) the radius of a 10″ (25 cm) 45 RPM long play record, and
(5) the radius of a 7″ (17.5 cm) 45 RPM single, and
(6) the radius of a 7″ (17.5 cm) 45 RPM extended play record,
ii. wherein said first lower circular spacer has a central circular cut-out, said central circular cut-out having as its center point the linear center axis of said threaded central shaft and a radius comprising a selection from a group consisting of:
(1) the radius of the paper label of a 12″ (30 cm) 33⅓ RPM long play record, and
(2) the radius of the paper label of a 12″ (30 cm) 33⅓ RPM maxi single record, and
(3) the radius of the paper label of a 12″ (30 cm) 45 RPM maxi single record, and
(4) the radius of the paper label of a 10″ (25 cm) 45 RPM long play record, and
(5) the radius of the paper label of a 7″ (17.5 cm) 45 RPM single, and
(6) the radius of the paper label of a 7″ (17.5 cm) 45 RPM extended play record,
iii. wherein said first lower circular spacer is constructed from a material comprising a selection from a group consisting of:
(1) neoprene, and
(2) high-density polyethylene (HDPE), and
(3) polyetheretherketone (PEEK), and
(4) polymethylmethacrylate (PMMA), and
(5) metal, and
(6) glass, and
(7) stone,
d) a first upper circular spacer:
i. wherein said first upper circular spacer has an outer radius about ¼″ less than the radius of the record to be used with the appliance, said radius comprising a selection from a group consisting of:
(1) the radius of a 12″ (30 cm) 33⅓ RPM long play record, and
(2) the radius of a 12″ (30 cm) 33⅓ RPM maxi single record, and
(3) the radius of a 12″ (30 cm) 45 RPM maxi single record, and
(4) the radius of a 10″ (25 cm) 45 RPM long play record, and
(5) the radius of a 7″ (17.5 cm) 45 RPM single, and
(6) the radius of a 7″ (17.5 cm) 45 RPM extended play record,
ii. wherein said first upper circular spacer has a central circular cut-out, said central circular cut-out having as its center point the linear center axis of said threaded central shaft and a radius comprising a selection from a group consisting of:
(1) the radius of the paper label of a 12″ (30 cm) 33⅓ RPM long play record, and
(2) the radius of the paper label of a 12″ (30 cm) 33⅓ RPM maxi single record, and
(3) the radius of the paper label of a 12″ (30 cm) 45 RPM maxi single record, and
(4) the radius of the paper label of a 10″ (25 cm) 45 RPM long play record, and
(5) the radius of the paper label of a 7″ (17.5 cm) 45 RPM single, and
(6) the radius of the paper label of a 7″ (17.5 cm) 45 RPM extended play record,
iii. wherein said first upper circular spacer is constructed from a material comprising a selection from a group consisting of:
(1) neoprene, and
(2) high-density polyethylene (HDPE), and
(3) polyetheretherketone (PEEK), and
(4) polymethylmethacrylate (PMMA), and
(5) metal, and
(6) glass, and
(7) stone,
e) a flat, circular top plate of large radius with a central perforate hole equal in diameter to the diameter of said threaded central shaft thus allowing said circular top plate to be placed over said threaded central shaft and weighing in the range of between about 3 pounds and about 6 pounds and constructed from a material comprising a selection from a group consisting of:
i. metal, and
ii. glass, and
iii. ceramic, and
iv. stone,
f) a knob, screwably affixable to said threaded central shaft to secure all the forgoing elements together in a first stack with the record to be de-warped insinuated between said first lower circular spacer and said first upper circular spacer.

2. A first improved de-warping device, further comprising
a) an electrically heated pouch, such that said first stack may be placed inside said electrically heated pouch:
i. wherein said electrically heated pouch is constructed from a material selected from a group consisting of:
(1) fire-resistant cloth or synthetic cloth with carbon fiber heating elements, and
(2) carbon nanotube heating cloth, and
(3) fire-resistant cloth or synthetic cloth with Teflon Microwire™ heating elements, and
(4) fire-resistant cloth or synthetic cloth with conventional heating wires,
ii. wherein the temperature of said electrically heated pouch may set using a thermostat,
iii. wherein said electrically heated pouch is powered by low-voltage DC electrical current.

3. A second improved de-warping appliance for vinyl records, comprising:
a) a flat, circular base plate of large radius constructed from a material comprising a selection from a group consisting of:
i. metal, and
ii. glass, and
iii. ceramic, and
iv. stone;
b) a threaded central shaft projecting perpendicularly up from said circular base plate at the center point of said circular base plate;
c) a second lower circular spacer:
i. wherein said second lower circular spacer has an outer radius about ¼″ greater than the radius of the record to be used with the appliance, said radius comprising a selection from a group consisting of:
(1) the radius of a 12″ (30 cm) 33⅓ RPM long play record, and
(2) the radius of a 12″ (30 cm) 33⅓ RPM maxi single record, and
(3) the radius of a 12″ (30 cm) 45 RPM maxi single record, and
(4) the radius of a 10″ (25 cm) 45 RPM long play record, and
(5) the radius of a 7″ (17.5 cm) 45 RPM single, and
(6) the radius of a 7″ (17.5 cm) 45 RPM extended play record,
ii. wherein said second lower circular spacer has a central perforate hole equal in diameter to the diameter of said threaded central shaft thus allowing said second lower spacer to be placed over said threaded central shaft,
iii. wherein said second lower circular spacer is constructed from a material comprising a selection from a group consisting of:
(1) felt, and
(2) polyester felt, and
(3) compressible rubber, and
(4) foam rubber, and
(5) plastic foam sheet,
d) a second upper circular spacer:
i. wherein said second upper circular spacer has an outer radius about ¼″ greater than the radius of the record to be used with the appliance, said radius comprising a selection from a group consisting of:
(1) the radius of a 12″ (30 cm) 33⅓ RPM long play record, and
(2) the radius of a 12″ (30 cm) 33⅓ RPM maxi single record, and
(3) the radius of a 12″ (30 cm) 45 RPM maxi single record, and
(4) the radius of a 10″ (25 cm) 45 RPM long play record, and
(5) the radius of a 7″ (17.5 cm) 45 RPM single, and
(6) the radius of a 7″ (17.5 cm) 45 RPM extended play record,
ii. wherein said second upper circular spacer has a central perforate hole equal in diameter to the diameter of said threaded central shaft thus allowing said second upper circular spacer to be placed over said threaded central shaft,
iii. wherein said second upper circular spacer is constructed from a material comprising a selection from a group consisting of:
(1) felt, and
(2) polyester felt, and
(3) compressible rubber, and
(4) foam rubber, and
(5) plastic foam sheet,
e) a flat, circular top plate of large radius with a central perforate hole equal in diameter to the diameter of said threaded central shaft thus allowing said circular top plate to be placed over said threaded central shaft and weighing in the range of between about 3 pounds and about 6 pounds and constructed from a material comprising a selection from a group consisting of:
i. metal, and
ii. glass, and
iii. ceramic, and
iv. stone,
f) a knob, screwably affixable to said threaded central shaft to secure all the forgoing elements together in a second stack with the record to be de-warped insinuated between said second lower circular spacer and said second upper circular spacer.

4. A second improved de-warping device, further comprising
a) an electrically heated pouch, such that said second stack may be placed inside said electrically heated pouch:
i. wherein said electrically heated pouch is constructed from a material selected from a group consisting of:
(1) fire-resistant cloth or synthetic cloth with carbon fiber heating elements, and
(2) carbon nanotube heating cloth, and
(3) fire-resistant cloth or synthetic cloth with Teflon Microwire™ heating elements, and
(4) fire-resistant cloth or synthetic cloth with conventional heating wires,
ii. wherein the temperature of said electrically heated pouch may set using a thermostat,
iii. wherein said electrically heated pouch is powered by low-voltage DC electrical current.

5. A first method of de-warping a warped record comprising the steps of:
a) placing said central circular cut-out of said first lower circular spacer over said threaded central shaft extending perpendicularly from said circular base plate such that the center point of said circular cut-out of said first lower circular space coincides with the linear center axis of said threaded central shaft;
b) placing the record to be de-warped onto said first lower circular spacer by passing the central hole of the said record over said threaded central shaft such that the peripheral lead-in portion of said record extends evenly beyond the outer edge of said first lower circular spacer and the paper label affixed to the bottom surface of said record rests in said central circular cut-out of said first lower circular spacer;
c) placing said central circular cut-out of said first upper circular spacer over said threaded central shaft extending perpendicularly from said circular base plate such that the center point of said circular cut-out of said first upper circular space coincides with the linear center axis of said threaded central shaft and such that the peripheral lead-in portion of said record extends beyond the outer edge of said first upper circular spacer and the paper label affixed to the top surface of said record rests in said central circular cut-out of said first upper circular spacer;
d) placing said central perforate hole of said circular top plate over said threaded central shaft;
e) screwably affixing said knob onto said threaded central shaft to secure all the forgoing elements together into said first stack;
f) placing said first stack in said electrically heated pouch for a period of time ranging between about 4 hours to about 20 hours.

6. A second method of de-warping a warped record comprising the steps of:
a) placing said central perforate hole of said second lower circular spacer over said threaded central shaft extending perpendicularly from said circular base plate;
b) placing the record to be de-warped onto said second lower circular spacer by passing the central hole of the said record over said threaded central shaft such that the outer edge of said second lower circular spacer extends evenly beyond the peripheral lead-in portion of said record;
c) placing said central perforate hole of said second upper circular spacer over said threaded central shaft extending perpendicularly from said circular base plate such that the outer edge of said second upper circular spacer extends evenly beyond the peripheral lead-in portion of said record;
d) placing said central perforate hole of said circular top plate over said threaded central shaft;
e) screwably affixing said knob onto said threaded central shaft to secure all the forgoing elements together into said second stack;
f) placing said second stack in said electrically heated pouch for a period of time ranging between about 4 hours to about 20 hours.
